(19) United States
(12) Patent Application Publication
(10) Pub. No.: US 2026/0077416 A1
(43) Pub. Date: Mar. 19, 2026

(54) Frangible Taps and Related Methods

(71) Applicant: Gecko Tail Tool LLC, Clearfield, UT (US)

(72) Inventors: Michael Christian Porter Sparzo, Clearfield, UT (US); Bryan James Crotwell, South Weber, UT (US)

(73) Assignee: Gecko Tail Tool LLC, Clearfield, UT (US)

(21) Appl. No.: 18/887,426

(22) Filed: Sep. 17, 2024

(51) Int. Cl. B23G 5/06

(52) U.S. Cl. CPC B23G 5/064

(57) ABSTRACT

A frangible tap may include a drive shaped and sized to be driven by a manual or power driver to rotate the frangible tap. The frangible tap may include a shank coupled with the drive. The frangible tap may include a threaded section coupled with the shank, the threaded section comprising a plurality of teeth configured to form threads in a bore by rotation of the threaded section within the bore. A frangible section may be formed in one of the shank and the drive, the frangible section configured to be weaker than the threaded section under torsion, such that the frangible section is configured to fracture under a torsional stress lower than what would fracture the threaded section.

### BACKGROUND

### 1. Technical Field

Aspects of this document relate generally to taps used to create threads.

### 2. Background Art

A tap is a tool used to create threads in a cavity or bore. Taps and dies exist in the art and may be used to form a mating pair—with a tap being used to create threads in a female portion of the mating pair (for example a bore or nut) and the die being used to create threads in a male portion of the pair (for example a bolt or screw).

### SUMMARY

In some aspects, the techniques described herein relate to a frangible tap, including: a drive shaped and sized to be driven by a manual or power driver to rotate the frangible tap; a shank coupled with the drive; a threaded section coupled with the shank, the threaded section including a plurality of teeth configured to form threads in a bore by rotation of the threaded section within the bore; and a frangible section formed in one of the shank and the drive, the frangible section configured to be weaker than the threaded section under torsion, such that the frangible section is configured to fracture under a torsional stress lower than what would fracture the threaded section.

In some aspects, the techniques described herein relate to a frangible tap, wherein the frangible section includes a recess or a cavity.

In some aspects, the techniques described herein relate to a frangible tap, wherein a presence of the recess or the cavity causes the frangible section to have a cross-sectional area smaller than a smallest cross-sectional area of a portion of the threaded section engaged with a sidewall of the bore, both cross-sectional areas taken orthogonal to a rotational axis of the frangible tap.

In some aspects, the techniques described herein relate to a frangible tap, wherein all of the frangible section is located above the threaded section and below the drive.

In some aspects, the techniques described herein relate to a frangible tap, further including a plurality of flutes extending at least partially into the threaded section, and wherein all of the frangible section is located above the plurality of flutes and below the drive.

In some aspects, the techniques described herein relate to a frangible tap, wherein the frangible section is configured to fracture under the torsional stress due to having a modified section that is weakened, relative to the threaded section, using a thermal treatment.

In some aspects, the techniques described herein relate to a frangible tap, wherein the frangible section is configured to fracture under the torsional stress due to having a modified section that is weakened, relative to the threaded section, using microfractures or microcracks.

In some aspects, the techniques described herein relate to a frangible tap, including: a drive shaped and sized to be driven by a manual or power driver to rotate the frangible tap; a shank coupled with the drive; a threaded section coupled with the shank, the threaded section including a plurality of teeth configured to form threads in a bore by rotation of the threaded section within the bore; and a frangible section in one of the shank and the drive, the frangible section including a recess or a cavity; wherein a presence of the recess or the cavity causes the frangible section to have a cross-sectional area smaller than a smallest cross-sectional area of a portion of the threaded section engaged with a sidewall of the bore, both cross-sectional areas taken orthogonal to a rotational axis of the frangible tap; and wherein, due at least in part to the cross-sectional area of the frangible section, the frangible section is configured to be weaker than the threaded section under torsion, such that the frangible section is configured to fracture under a torsional stress lower than what would fracture the threaded section.

In some aspects, the techniques described herein relate to a frangible tap, wherein the frangible section includes the cavity, and wherein the cavity is not visible at an outer surface of the shank.

In some aspects, the techniques described herein relate to a frangible tap, wherein the frangible section includes the recess, and wherein the recess is formed into a notch including at least two flat surfaces having an angle therebetween.

In some aspects, the techniques described herein relate to a frangible tap, wherein the frangible section includes the recess, and wherein the recess encircles the shank in a helical manner.

In some aspects, the techniques described herein relate to a frangible tap, wherein all of the frangible section is located above the threaded section and below the drive.

In some aspects, the techniques described herein relate to a frangible tap, further including a plurality of flutes extending at least partially into the threaded section, wherein all of the frangible section is located above the plurality of flutes and below the drive, and wherein the shank is substantially cylindrical except for the frangible section and except for the plurality of flutes.

In some aspects, the techniques described herein relate to a frangible tap, wherein the frangible section includes the cavity, and wherein the cavity is accessible through at least two openings in an outer surface of the shank.

In some aspects, the techniques described herein relate to a frangible tap, wherein the frangible section includes the cavity, and wherein the cavity includes a blind hole that is accessible through an opening in the drive but that is not accessible through any outer surface of the shank.

In some aspects, the techniques described herein relate to a frangible tap, wherein the frangible section includes the recess as well as one or more other recesses together forming a plurality of recesses, wherein the plurality of recesses are symmetric to one another relative to the rotational axis of the frangible tap.

In some aspects, the techniques described herein relate to a frangible tap, wherein the frangible section includes the recess as well as one or more other recesses together forming a plurality of recesses, wherein the plurality of recesses are asymmetric to one another relative to the rotational axis of the frangible tap.

In some aspects, the techniques described herein relate to a method of forming a frangible tap, including: forming a frangible section in a tap, the tap including: a drive shaped and sized to be driven by a manual or power driver to rotate the tap; a shank coupled with the drive; and a threaded section coupled with the shank, the threaded section having a plurality of teeth configured to form threads in a bore by rotation of the threaded section within the bore; wherein the frangible section is formed in one of the shank and the drive; and wherein the frangible section is weaker than the threaded section under torsion, such that the frangible section is configured to fracture under a torsional stress lower than what would fracture the threaded section.

In some aspects, the techniques described herein relate to a method, wherein forming the frangible section includes forming a recess or a cavity in one of the shank and the drive, wherein a presence of the recess or the cavity causes the frangible section to have a cross-sectional area smaller than a smallest cross-sectional area of a portion of the threaded section configured to engage a bore during a threading operation, both cross-sectional areas taken orthogonal to a rotational axis of the frangible tap.

In some aspects, the techniques described herein relate to a method, wherein forming the frangible section includes weakening a portion of one of the shank and the drive to reduce a maximum supportable torsional stress by: applying a thermal treatment; or introducing microcracks or microfractures.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a front, left view of a prior art tap;

FIG. 2 is a front, partial see-through view of a fractured tap of FIG. 1 in a bore;

FIG. 3 is a right, front view of an implementation of a frangible tap;

FIG. 4 is a right, top, perspective view of the frangible tap of FIG. 3;

FIG. 5 is a left, front, bottom, cross-section, perspective view of the frangible tap of FIG. 3;

FIG. 6 is a rear, left, bottom, cross-section, perspective view of the frangible tap of FIG. 3;

FIG. 7 is a front, left, top, perspective view of another implementation of a frangible tap;

FIG. 8 is a front, right view of another implementation of a frangible tap;

FIG. 9 is a front, right, top, perspective view of another implementation of a frangible tap;

FIG. 10 is a front, right view of another implementation of a frangible tap;

FIG. 11 is a front, right view of another implementation of a frangible tap;

FIG. 12 is a front, right view of another implementation of a frangible tap;

FIG. 13 is a front, right, top, perspective view of another implementation of a frangible tap;

FIG. 14 is a front, right view of another implementation of a frangible tap;

FIG. 15 is a front, partial see-through view of a fractured frangible tap of FIG. 3 in a bore;

FIG. 16 is a front view of the frangible tap of FIG. 3;

FIG. 17 is a front view of another implementation of a frangible tap;

FIG. 18 is a front view of another implementation of a frangible tap; and

FIG. 19 is a front, right, top perspective view of another implementation of a frangible tap.

### DESCRIPTION

Implementations/embodiments disclosed herein (including those not expressly discussed in detail) are not limited to the particular components or procedures described herein. Additional or alternative components, assembly procedures, and/or methods of use consistent with the intended frangible taps and related methods may be utilized in any implementation. This may include any materials, components, sub-components, methods, sub-methods, steps, and so forth.

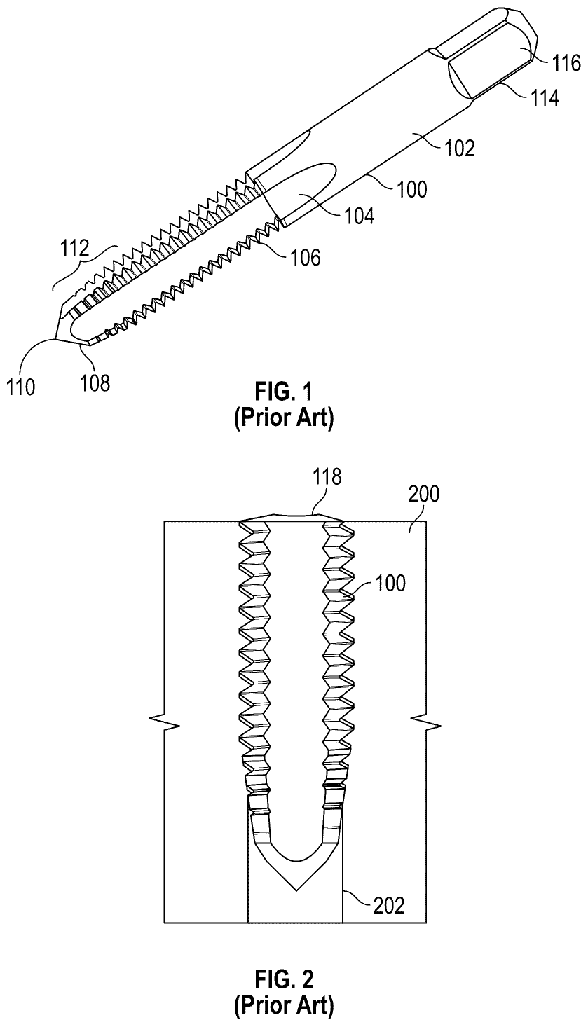

Reference will now be made to FIGS. 1-2 which show a conventional tap 100. FIG. 1 is a front, left view of the conventional, prior art tap. The conventional tap 100 includes a shank 102 (which in the shown example generally forms a cylinder), a drive 114 proximate a top of the shank (and having a plurality of faces 116), and a threaded portion below the shank. The threaded portion includes teeth 106 which are configured to form threads in a bore, cavity, nut, or so forth. The teeth are generally organized into discontinuous threads (made discontinuous by flutes 104 which extend from a lower portion of the shank to proximate a bottom of the threaded portion). The shown conventional tap 100 further has a tapered portion 112 existing in the threaded portion, and at a bottom of the threaded portion is a conical portion 108 terminating in a tip 110.

A variety of conventional taps exist in the art, and the version shown in FIG. 1 is only one example. Other prior art taps exclude the taper and/or the conical portion 108 and tip 110. For example some prior art taps have a flat bottom and no taper (e.g., a bottoming tap) or a flat bottom and a taper (e.g., a plug tap), and so forth. Any such conventional taps could be modified to form a frangible tap using the mechanisms/steps disclosed herein. For example any type of conventional tap, whether disclosed herein or otherwise, could have a frangible section added thereto, such as any of the frangible sections disclosed or described herein, to form a frangible tap. Alternatively, a frangible tap may be initially formed having a frangible section combined with any otherwise conventional tap configuration/design (as opposed to taking an existing tap and thereafter modifying it to form the frangible section).

FIG. 2 is a front, partial see-through view of a fractured tap of FIG. 1 in a bore. The conventional tap 100 of FIG. 2 may be used to form threads within a cavity 202 (which is a cylindrical bore) in a material 200 (which may be any material, for example a metal, metal alloy, composite, polymer, wood, and so forth). FIG. 2 shows the conventional tap 100 having fractured, during the threading operation, proximate the threaded section (or in other words proximate the teeth 106), forming fracture 118. Due to the fracture being so close to the top of material 200, it is difficult to remove the threaded portion from the cavity 202, as there is very little of the conventional tap 100 that juts out above the top opening of the cavity 202. In some cases there may be more of the conventional tap 100 sticking out above the opening after a fracture, or in some cases the fracture may even exist within the cavity 202 itself (below the top opening of the bore). In either case, such a fracture renders it difficult to remove the threaded portion or the bottom remainder of the broken tap due to there being no, or very little, of the bottom remainder of the tap for a wrench or other tool to grab onto for removal.

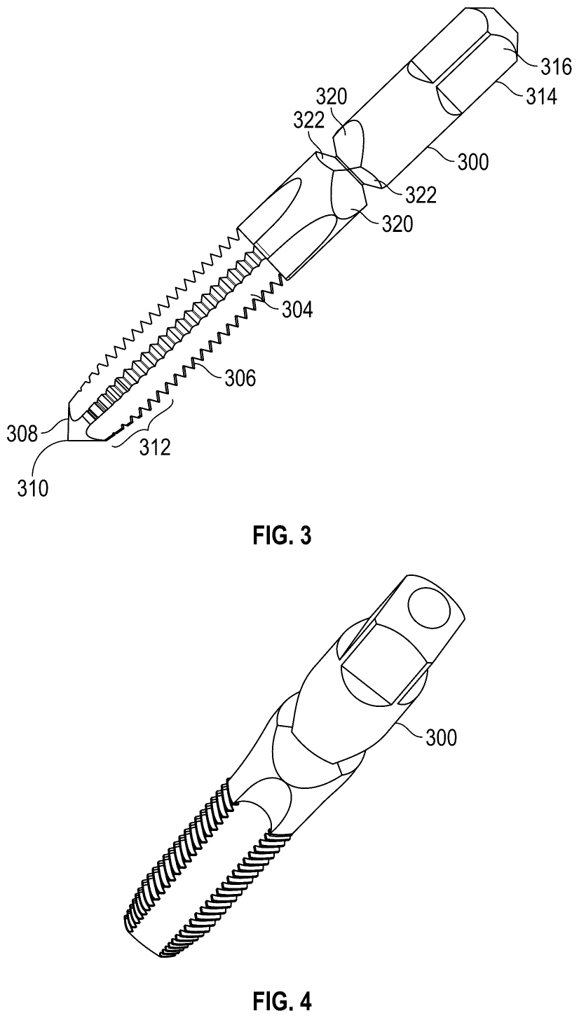

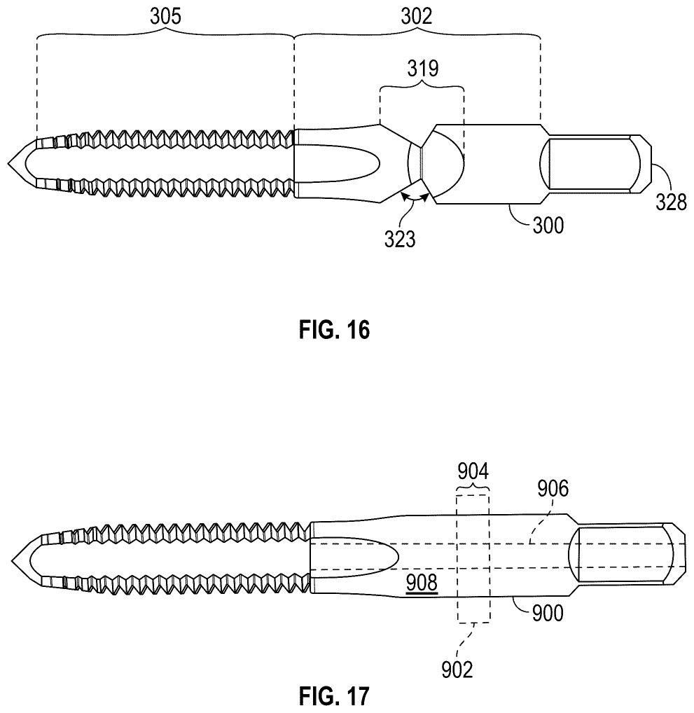

Reference will now be made to FIGS. 3-6 and 15-16 which discuss a frangible tap 300. FIG. 3 is a right, front view of an implementation of a frangible tap. Frangible tap 300 may also be called a threading tap in as much as it is configured to form threads. Frangible tap 300 includes a shank 302 (which may also be called a shank portion or a shank section of the frangible tap) which has a generally cylindrical shape except for a frangible section 319 (which will be discussed hereafter) and except for flutes 304. In implementations the shank need not have a generally cylindrical shape—for example it could have a generally cuboidal shape (having a square or rectangular cross section) or have any other shape so long as its shape and size do not interfere with or otherwise frustrate the threading operation by the teeth.

A drive 314 is positioned atop the shank and includes a plurality of faces 316. The drive may be a standard square drive such as a ¼-inch drive, a ⅜-inch drive, a ½-inch drive, or any other drive size/configuration, and may be configured to pair with a manual or powered/power driver to rotate the frangible tap 300 for a threading operation (and to rotate the frangible tap 300 in an opposite rotation for removal of the frangible tap thereafter). In implementations the drive need not have a square configuration, but could have some other configuration—and it could also have sizes other than those above so long as it is configured to be driven by a correspondingly sized and shaped manual or power driver for rotation. The top of the drive forms a top 328 of the frangible tap 300.

A threaded portion 305 (which may also be called a threaded section) extends below the shank and includes teeth 306.

These are organized into discontinuous threads, the threads made discontinuous by flutes 304 which extend from a lower portion of the shank 302 and into the threaded portion 305. The threaded portion includes a tapered portion 312. Below the threaded portion 305 is a conical portion 308 terminating in a tip 310 (which may also be called a bottom or a bottom tip). The tip 310 forms a bottom of the frangible tap 300.

The frangible section 319 is formed by notches that are formed into the shank 302, forming first surfaces 320 and second surfaces 322 having an angle 323 therebetween. In the shown implementation the angle is a 90-degree angle but the notches could, in other implementations, form a greater or smaller angle between the respective surfaces. Each angle 323 is formed by a first surface and a second surface, the first surfaces 320 generally being larger than the second surfaces 322. The frangible section 319 is seen to have a configuration with alternating first surfaces 320 and second surfaces 322. In other words, the surfaces closest to the threaded portion 305 alternate between first surfaces 320 and second surfaces 322 and the surfaces closest to the drive 314 similarly alternate between second surfaces 322 and first surfaces 320, respectively.

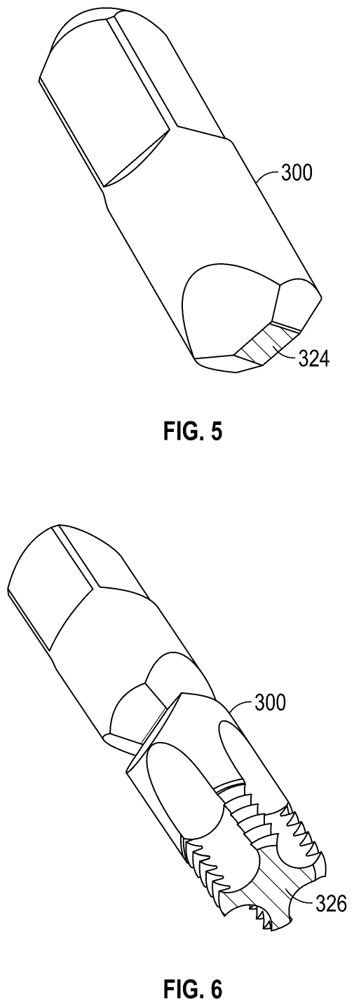

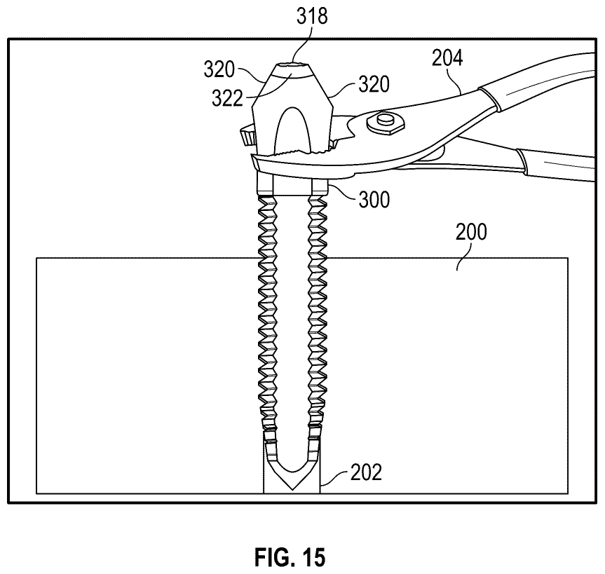

FIG. 4 is a right, top, perspective view of the frangible tap of FIG. 3. FIG. 5 is a left, front, bottom, cross-section, perspective view of the frangible tap of FIG. 3. FIG. 6 is a rear, left, bottom, cross-section, perspective view of the frangible tap of FIG. 3. FIGS. 5-6 illustrate that the frangible section 319 has a smallest cross-sectional area 324 smaller than a smallest cross-sectional area 326 of the threaded portion 305 (or, in implementations, smaller than a smallest cross-sectional area 326 of a portion of the threaded portion 305 configured to engage a sidewall of a bore being threaded). This tends to cause the frangible tap 300 to fail by producing a fracture 318 at the frangible section 319 instead of at or near the threaded portion 305. As shown in FIG. 15, such a fracture leaves a significant portion of the remainder of the frangible tap above the opening of a cavity 202 or the like, so that it can be more easily removed using a wrench 204 or other manual or powered tool.

The notches of frangible section 319 are only an example of a configuration of material removed from the shank. Material could alternatively be removed to form any other shape or profile in the shank. The removed material in all cases may form a recess or void in the shank. In each case, the respective frangible section may be configured such that the tap tends to fail by rupturing at the frangible section, instead of at any of the teeth, thus facilitating removal of the remainder with conventional tools. The recesses or cavities forming the frangible section are herein discussed as removed material, and they may indeed be formed such as, by non-limiting examples, using cutting (such as on a lathe), grinding (such as on a tool sharpener), and so forth. Alternatively, they may be integrally formed during the initial formation of the shank (such as by forging, pressing, molding, etc.) even if this doesn't technically require removal of material to form the frangible section. In some implementations the frangible section may be formed during the manufacture of the rest of the frangible tap, or it may alternatively be formed in post-manufacturing of the threading tap as a separate operation.

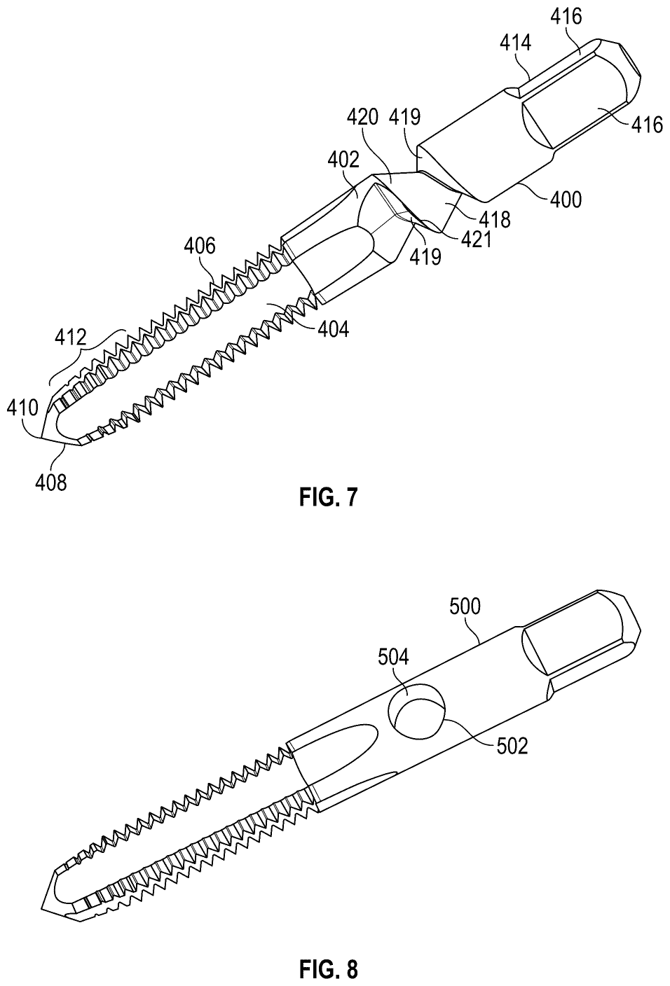

FIG. 7 is a front, left, top, perspective view of another implementation of a frangible tap. Frangible tap 400 includes a shank 402 which is generally cylindrical except for a frangible section 418 and except for flutes 404 which extend from a lower portion of the shank into a threaded portion or threaded section. The threaded portion has teeth 406 which form or are organized into discontinuous threads (made discontinuous by the flutes), and which are configured to perform a threading operation by forming threads in a cavity or bore hole of a material or nut or so forth. The threaded portion includes a tapered portion 412, and below the threaded portion is a conical portion 408 which terminates in a tip 410. Atop the shank is a drive 414 which has a plurality of faces 416.

The frangible section 418 has a helical configuration, being formed of a first surface 419 facing partially downward (toward the threaded section of the tap) and a second surface 420 facing partially upward (toward the drive or top of the tap), these two surfaces meeting at a helical line 421 (or spiral line) which spirals around the shank. The frangible section 418 accordingly comprises a recess encircling the shank in a helical manner. This configuration effectively results in a helical or spiral groove/recess of removed (or absent) material around the shank. This configuration provides a plurality of low cross-sectional area locations or otherwise provides a plurality of shear/rupture locations in the frangible section that are configured to fracture or shear before any portion of the threaded section would shear. This is useful, by non-limiting example, for preventing unintended damage to the tap (or the material or bore/cavity being threaded) after the initial fracture when, due to the use of an automated powered driver (or otherwise due to lack of detecting the initial fracture) the driver continues to rotate the drive and/or continues to advance it axially toward the broken section of the tap. In such an instance the frangible section is configured to fracture multiple times (or continuously) in order to absorb the energy of the continued advance/rotation instead of causing damage to the tap (or fracture of the tap) along the threaded section and instead of damaging the threaded portion of the cavity or bore or the like being threaded.

FIGS. 8-14 and 17-19 show various frangible taps that are in many ways identical or very similar to frangible tap 300 and frangible tap 400 except for having different frangible sections. Each of these taps has a shank that is generally cylindrical except for the frangible section and except for flutes which extend from a lower portion of the shank down along a threaded section. Atop each shank is a drive which forms a plurality of faces, and the top of each drive forms a top of the respective frangible tap. The threaded section of each includes teeth which form or are organized into discontinuous threads (made discontinuous by the flutes) and which are used to form threads in a cavity or bore or so forth. Each threaded section includes a tapered portion, and below each threaded section is a conical portion which terminates in a tip, the tip forming a bottom of the respective tap. The frangible section of each of these frangible taps is, nevertheless, distinct, and so the frangible section of each is discussed below.

FIG. 8 is a front, right view of frangible tap 500. As discussed above, it is similar or identical to other frangible taps discussed herein except for the frangible section. The frangible section of frangible tap 500 includes a through-hole 502 passing through the shank. The through-hole 502 forms or is defined/bordered by inner surface 504 which has a cylindrical shape. The through-hole is, as can be seen, a cavity accessible through two openings in an outer surface of the shank (though in some cases it could be accessible through more openings in the outer surface of the shank). Frangible tap 500 is configured to rupture/fail at the frangible section, e.g., at the through-hole 502, due to the reduced cross-sectional area at the through-hole 502 (taken perpendicular to an axis of rotation of the frangible tap 500) relative to the cross-sectional area at the threaded section or relative to a smallest cross-sectional area of a portion of the threaded section engaging a sidewall of a bore during a threading operation.

FIG. 8 illustrates an example of a frangible tap 500 having a circular through-hole 502, but in other implementations the through-hole could have any other shape or cross-section. Additionally, in FIG. 8 the through-hole has sidewalls that are fully defined by inner surface 504 but, as may be imagined, a similar through-hole or recess could be formed that is not fully contained within the shank. For example, through-hole 502 could be formed by drilling a hole through the axis of the shank, but a drill bit could instead be positioned so that the diameter of the drill bit is offset from the shank axis, so that the drill bit diameter extends beyond the outer surface of the shank and so that the resulting removed material forms a recess in the shank instead of a fully-contained through hole. This may also be described as a partial hole whose assumed hole diameter exists at least partially outside the diameter of the shank. Further, the through-hole 502 shown in FIG. 8 has a diameter perpendicular to the axis of rotation of the frangible tap, but in other implementations the hole could be formed at any angle such that the diameter (or axis of rotation of the drill bit or other item used to form the through-hole) is positioned not fully perpendicular to the axis of rotation of the frangible tap, but at an angle thereto.

One other example for the frangible section, though not specifically shown in the drawings, would be to have recesses in the form of grooves equally spaced around the outer circumference of the shank, each groove at the same linear position along the shank relative to the longest length of the shank. In other words, each groove could have a lower end the same distance from the bottom or tip of the frangible tap, and an upper end the same distance from the top of the frangible tap. Such a plurality of recesses may be designed to reduce the cross-sectional area of the frangible tap at a portion of the shank, relative to the smallest cross-sectional area of the threaded section (or relative to the smallest cross-sectional area of a portion of the threaded section engaging a sidewall of a bore being threaded), to effectively form a frangible section configured to break before the threaded section would break.

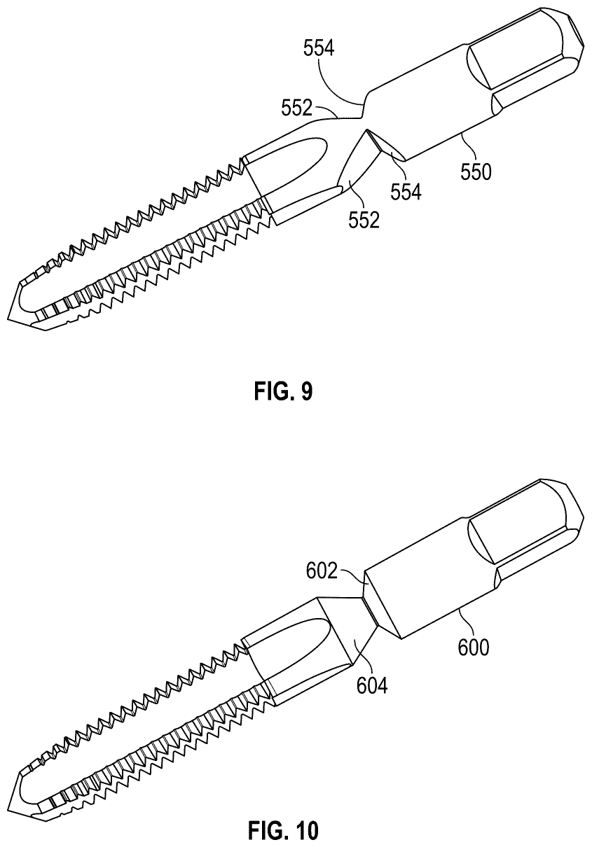

FIG. 9 is a front, right, top, perspective view of frangible tap 550. As discussed above, it is similar or identical to other frangible taps discussed herein except for the frangible section, which includes two symmetric or mirrored notches placed in the shank on opposite sides of the shank. Each notch forms a first surface 552 and a second surface 554. In FIG. 9 it can be seen that the plane of each first surface 552 intersects with one of the flutes. The first and second surfaces are flat and an angle is formed between each pair. In the shown example this angle is 90 degrees, but in other implementations it could be less than or greater than 90 degrees. Additionally, in FIG. 9 it is seen that the notches are formed at 180 degrees from one another along the outer circumference of the shank, but in other implementations the notches could be formed at various other positions relative to one another, such as 90 degrees from one another along the circumference of the shank, or any other angle, notwithstanding that this may result in the notches intersecting one another. The notches of frangible tap 550 may be formed by cutting tools or the like.

FIG. 10 is a front, right view of frangible tap 600. As discussed above, it is similar or identical to other frangible taps discussed herein except for the frangible section, which includes a recess forming a reduced diameter along a full circumference of the shank (in other implementations the reduced diameter could be cut or formed only along one or more portions of the circumference of the shank). A cutting tool could be used to form such a reduced diameter having a plurality of shapes. For example, a rectangular cutting tool might be used to form a reduced-diameter recess that has a cross section of a rectangle or square when viewed from the front (as in FIG. 10)—in such an instance the smallest diameter of the shank, at the cut portion, would be immediately adjacent to the full shank diameter outside the frangible section. In other implementations, though, as in the example of FIG. 10, the smallest diameter of the frangible section is tapered to, such as (by non-limiting example) using the conical profiles (i.e., formed by an angled cutting edge) shown in FIG. 10. The recess of the frangible section of FIG. 10 is seen to have a triangular cross-section, forming a 90-degree angle between an upper surface 602 and lower surface 604 of the formed continuous notch which encircles the shank. In other implementations the angle between the surfaces could be any other angle greater than or less than 90 degrees. Additionally, the cutting tool used to form the notch of frangible tap 600 was angled such that the lower surface 604 has a greater surface area than the upper surface 602, but this could be reversed or the cutting tool could be angled so that they have equal surface areas, or to form any ratio of relative surface areas, as non-limiting examples.

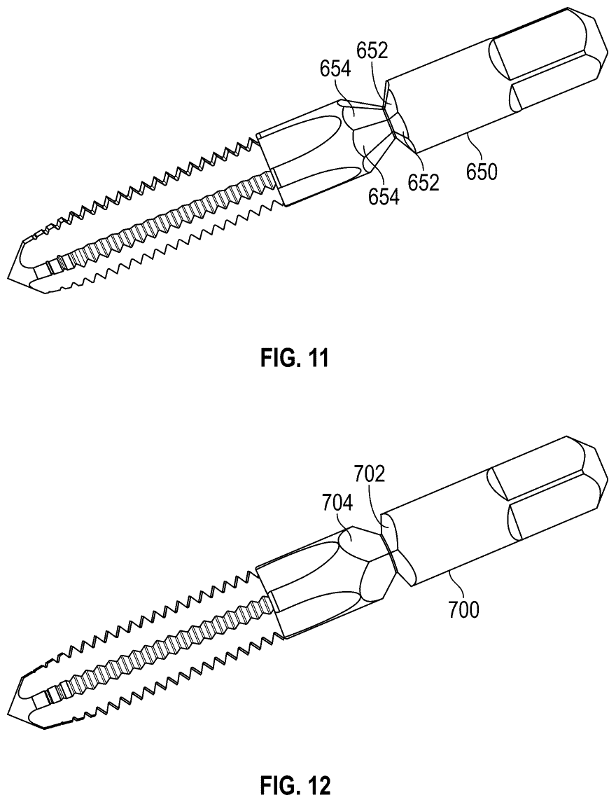

FIG. 11 is a front, right view of frangible tap 650. As discussed above, it is similar or identical to other frangible taps discussed herein except for the frangible section, which includes eight notches cut into the shank at 45-degrees relative to one another around the circumference of the shank. FIG. 12 is a front, right view of frangible tap 700, and it is also similar or identical to other frangible taps discussed herein except for the frangible section, which includes a plurality of notches cut into the shank. Frangible tap 700 includes four notches cut at 90-degrees relative to one another around the circumference of the shank. Frangible tap 700 and frangible tap 650 are discussed together because frangible tap 650 can be formed by taking frangible tap 700 and cutting four additional notches, each at 45 degrees to one of the four notches of frangible tap 700, using the same cutting tool/method as was used to form the notches of frangible tap 700. Indeed, while frangible tap 700 includes four notches, and frangible tap 650 includes eight notches, in other implementations the same mechanism/method could be used to form frangible taps having three or fewer such notches, or five to seven such notches, or nine or more such notches. In any case the notches could be equally spaced around the circumference, or not, as desired. When equally spaced the notches may intersect one another, as seen in FIGS. 11-12, or if they have other spacings they may or may not intersect one another.

The notches of frangible tap 650 are seen to each form an upper surface 652 and a lower surface 654, with the lower surface 654 having a greater surface area, but as discussed above with other frangible taps the angle of the cutting tool or other notch-forming tool may be adjusted so that this is reversed or so that the surface areas are equal or so that they have any ratio relative to one another. Similarly, the notches of frangible tap 700 are seen to each form an upper surface 702 and a lower surface 704 with the lower surface 704 having a greater surface area, but as discussed above with other frangible taps the angle of the cutting tool or other notch-forming tool may be adjusted so that this is reversed or so that the surface areas are equal or so that they have any ratio relative to one another. Similarly, the notches in each frangible tap 650 and frangible tap 700 form 90-degree angles, but the cutting tool or other notch-forming tool or mechanism may be adjusted or switched out so that the notches form any other angle lower or greater than 90 degrees between the upper and lower surfaces.

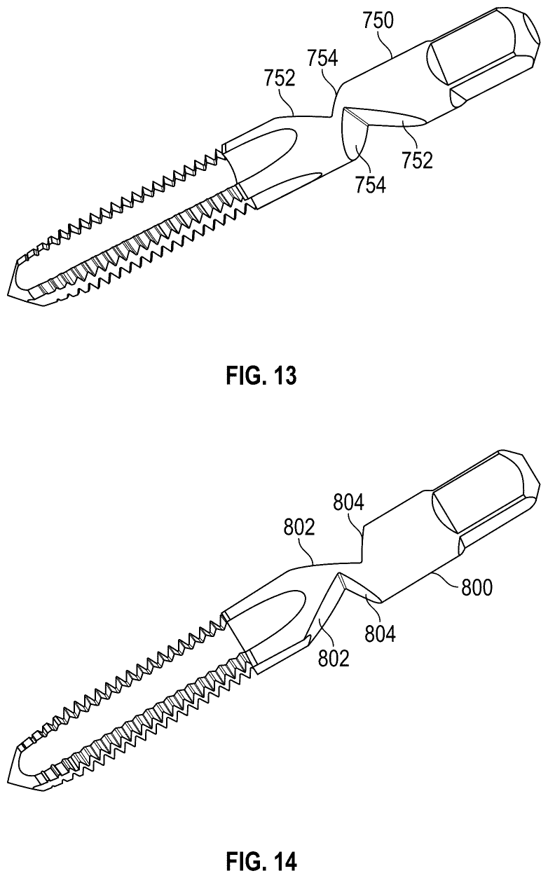

FIG. 13 is a front, right, top, perspective view of a frangible tap 750. As discussed above, it is similar or identical to other frangible taps discussed herein except for the frangible section. Frangible tap 750 may be formed using the same cutting tool or other notch-forming tool/mechanism as used to form frangible tap 550 except that the tool is reversed such that the notches of frangible tap 750 are asymmetric relative to one another and, additionally, located at different linear positions along the shank (measured from either the top or bottom of the frangible tap) to form a staggered notch pattern. This may provide for a unique breaking/fracturing behavior, which may be useful in some threading applications. For example, this may provide for a continuous fracturing frangible section, similar to that described herein for the helical or spiral frangible section, which may be useful in instances wherein the drive continues to rotate (either by automatic or manual force) after the initial rupture of the frangible section.

In FIG. 13 it can be seen that each notch forms a first surface 752 and second surface 754, with the first surface 752 having a greater surface area, with each pair of surfaces forming a 90-degree angle relative to one another, with the lowermost notch intersecting with one of the flutes (not seen but easily envisioned), and the two notches being positioned 180 degrees from one another along the circumference of the shank. As with other frangible taps various modifications could be made to form a variation of this frangible tap, including but not limited to: having only one such notch or having more than two such notches; positioning the notches at positions other than 180-degrees relative to one another, whether equally-spaced or otherwise; adjusting the angle between the first surfaces and second surfaces to lower than or greater than 90 degrees; adjusting the position of the cutting tool or other notch-forming tool or mechanism such that the surface areas of the first and second surfaces are equal, or so that the second surface 754 has a greater surface area than the first surface 752, or so that the surfaces have any other surface area ratio relative to one another; adjusting the relative axial position of the notches relative to one another (or adjusting the axial position of each relative to the bottom or top of the frangible tap); and so forth.

FIG. 14 is a front, right view of frangible tap 800. As discussed above, it is similar or identical to other frangible taps discussed herein except for the frangible section. The frangible section of frangible tap 800 is relatively similar to that of frangible tap 750 (and may be formed using the same cutting tool or other notch-forming tool or mechanism, and may have the same or similar dimensions, relative surface areas, angles, and so forth of the notches and their surfaces) except with frangible tap 750 the notch configurations are reversed relative to one another so that in one notch the first surface 752 is positioned lower and with the other the second surface 754 is positioned lower (with frangible tap 800 in both cases the first surfaces 802 are positioned lower than their corresponding second surfaces 804). The frangible section of frangible tap 800, and the notches, may be altered/varied in any of the ways described above for frangible tap 750. The first surface 802 of the lowermost notch is seen to intersect with one of the flutes. The notch configuration of frangible tap 800 is seen to be asymmetric.

In some cases the frangible section could be formed by using a cutting or grinding or other tool to form a flat recess in the shank. This recess may be similar to one of the faces of the drive, for example, except positioned somewhere along the shank so as to reduce the cross-sectional area of the shank thereat so that failure tends to occur there instead of at the threaded section.

In some cases the drive itself may be sized to have a smaller cross-sectional area than the smallest cross-sectional area of the threaded section (or smaller than a smallest cross-sectional area of a portion of the threaded section engaging a sidewall of a bore) so that, if the frangible tap fails, it tends to fail at the drive instead of at the threaded section. This may result in some difficulty (in some cases) removing the remainder of the drive from the manual or power driver but may nevertheless allow the bottom remainder of the frangible tap to be relatively easily extracted from the bore or cavity or other item being threaded.

FIG. 17 is a front view of frangible tap 900. As discussed above, it is similar or identical to other frangible taps discussed herein except for the frangible section. The shank of frangible tap 900 includes a modified section 902 (which, in implementations, is itself the frangible section). There are multiple ways in which this portion of the shank may be modified. One is by using one or more thermal treatments applied at or near the modified section 902 such that the shank is weakened thereat (relative to the remainder of the frangible tap), such that the frangible tap tends to break at the modified section as opposed to at the threaded section. Another way in which the modified section may be modified is through intentionally-introduced microcracks or microfractures at or near or within the modified section (this may also be referred to as artificial aging of the modified section). This could be done, by non-limiting example, by a tool gripping the shank below the modified section, and another (or corresponding) tool gripping the shank above the modified section, and intentionally creating some plastic deformation within the modified section (such as by a tensile pulling, a relative rotation/twisting/torsion, or repeated tensile pulling and/or contractions, or repeated or cyclic forward/reverse rotation/twisting/torsion, or any combination thereof) to form microcracks and/or microfractures at the modified section. In some cases a thermal treatment, such as a heating or cooling operation localized (or somewhat localized) to the modified section, or repeated or cyclic thermal operations (heating, cooling, cycling between heating/cooling, or any combination), alone or in combination with applying mechanical stress, may be used cause such microcracks or microfractures. In any case, the microcracks or microfractures are configured such that the frangible tap 900 tends to break at the modified section 902 instead of at the threaded section.

In implementations the thickness 904 of the modified section 902 may be adjusted in order to adjust the weakness of the modified section relative to the rest of the frangible tap. In implementations the modified section 902 (or, in other words, the distribution of weakened material having microcracks/microfractures or otherwise being weakened) forms a generally cylindrical section of the shank, but in other implementations the weakened portion may have any other shape, such as spherical, cylindrical with rounded caps, or any other regular or irregular shape within the shank or drive.

Frangible tap 900 is also seen to have a blind hole 906 drilled or otherwise formed within it. The blind hole 906 in the shown implementation is a cylindrical cavity extending from a top of the frangible tap 900 all the way through the drive, and all the way through the shank, and ending at the threaded section (but entirely within the frangible tap 900 and coaxial with its axis of rotation). The blind hole is, accordingly, a cavity that is accessible through an opening in the drive but that is not accessible through any outer surface of the shank. This blind hole reduces the cross-sectional area of the drive, and the shank, relative to the smallest cross-sectional area of the threaded section—and thus tends to cause the frangible tap 900 to fail at the shank or the drive, somewhere above the threaded section, instead of at the threaded section, so that the remainder of the frangible tap 900 may be removed from the cavity or bore or other item being threaded after a fracture.

In FIG. 17 the blind hole 906 is coaxial with the tap's axis of rotation but this is not necessary in all implementations, as it could be angled relative thereto and/or could have another opening at an outer surface 908 of the shank instead of only at a top of the drive (in which case it may not technically be a “blind” hole but simply a hole or cavity). When a blind hole 906 is used the frangible section technically extends all the way from the top of the drive to the bottom of the shank (adjacent the threaded section), as opposed to other frangible taps discussed herein wherein the frangible section exists somewhere between the bottom and top of the shank, respectively, but not extending all the way to the threaded section and not extending all the way to the drive.

Frangible tap 900 is an example of a frangible tap where there is not necessarily any visible modification to the outer surface 908 of the shank, such as no notches or other material removed or absent from the shank. While frangible tap 900 is illustrated as having both a modified section 902 and a blind hole 906, variations may include only one or the other, or both. Similarly, any elements of any frangible section discussed herein (such as notches, grooves, other recesses, through-holes, thermally or mechanically modified sections, microcracks, blind holes, etc.) may be combined in any combination to form a frangible tap.

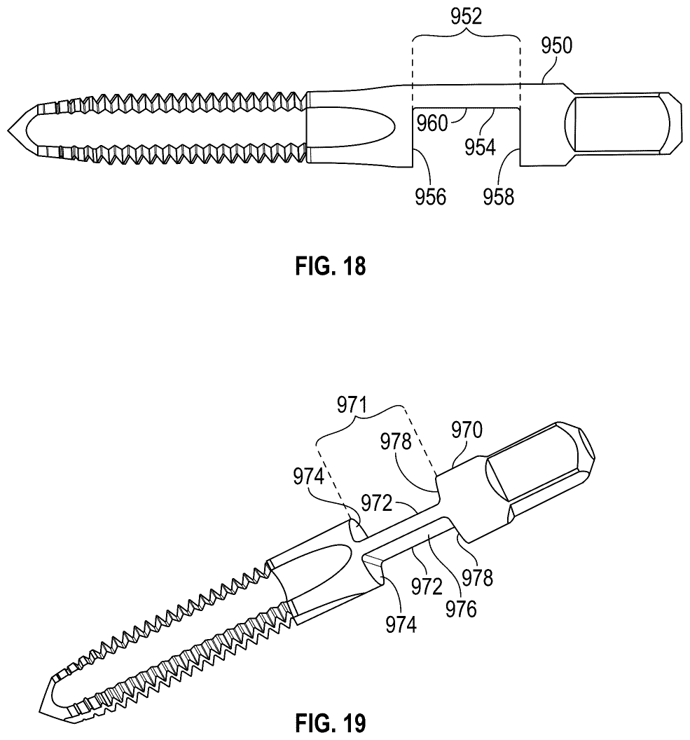

FIG. 18 is a front view of frangible tap 950. As discussed above, it is similar or identical to other frangible taps discussed herein except for the frangible section. The frangible section 952 includes a recess 954 in the shank, which is seen in FIG. 18 to be rectangular or rectangularly cuboidal in shape (and to extend past the axis of the frangible tap though, in other implementations, the depth of the recess could be greater or less than this, including not extending to or past the axis, and/or its lower surface 956 or upper surface 958 may be at different positions than those shown in the drawing). The recess accordingly forms surface 956, surface 958, and surface 960, and may be made for example with a grinding or cutting or other mechanical removal mechanism, such as any mechanism described herein or otherwise known in the art for material removal.

FIG. 19 is a front, right, top perspective view of frangible tap 970. As discussed above, it is similar or identical to other frangible taps discussed herein except for the frangible section. The frangible section 971 includes double (opposing) recesses 972 in the shank, which are seen in FIG. 19 to be rectangular or rectangularly cuboidal in shape (neither of which extends past the axis of the frangible tap though, in other implementations, the depths of the recesses could be varied so that one extends past the axis and the other doesn't, and/or varying the thickness or height of the remaining material defined by surfaces 976, and/or its lower surfaces 974 or upper surfaces 978 may be at different positions than those shown in the drawing). Each recess accordingly forms a bottom surface 974, a side surface 976, and a top surface 978, and may be made for example with a grinding or cutting or other mechanical removal mechanism, such as any mechanism described herein or otherwise known in the art for material removal.

While the recesses 954 and 972 are shown with rectangular or rectangularly cuboidal shapes, and essentially being flat at their side surfaces 960/976, bottom surfaces 956/974 and top surfaces 958/978, the shapes could be different in other configurations, for example the lower/bottom, upper/top, or side surfaces being rounded or otherwise non-rectangular. In any case, the configurations of FIGS. 18-19 may result in the frangible sections having a cross-section (perpendicular to the rotation axis of the frangible tap) that is smaller than a smallest cross-section of the threaded section (or smaller than a smallest cross-section of a portion of the threaded section that engages a bore during a threading operation), and this may facilitate the frangible section breaking before the threaded section would break. In other implementations, however, the frangible section may not have a smaller cross-section than the threaded section, and the shape, positioning, or other configuration of the frangible section may contribute to its fracturing before the threaded section would fracture.

As with other frangible taps described herein, the frangible taps of FIGS. 18-19 are in implementations configured to prevent unintended damage to the tap (or the material or bore/cavity being threaded) after the initial fracture when, due to the use of an automated powered driver (or otherwise due to lack of detecting the initial fracture) the driver continues to rotate the drive and/or continues to advance it axially toward the broken section of the tap. In such an instance the frangible section of frangible tap 950 or 970 is configured to fracture multiple times (or continuously) in order to absorb the energy of the continued advance/rotation instead of causing damage to the tap (or fracture of the tap) along the threaded section and instead of damaging the threaded portion of the cavity or bore or the like being threaded.

The various recesses, cavities, notches, openings, and the like shown in the drawings and described herein are only representative examples. In other implementations a recess, cavity, notch, opening (to a cavity), and the like may have any shape, size, number, orientation, position, and/or configuration and may still form and/or facilitate a frangible section which is configured to fail at a lower torsional stress then the threaded section. Accordingly, unless explicitly stated, the recesses, notches, cavities, openings (to cavities) and the like claimed below are not limited to the specific shapes, sizes, configurations, number, orientations, positions, and the like given in the specific examples herein.

All of the flutes shown in the drawings are seen to be straight flutes, but in other implementations they could take on any other configuration, such as spiral flutes which spiral in one rotation or another around a portion of the shank and/or around a portion of the threaded portion. In some implementations the flutes could be excluded (for example implementations of creating threads in softer metals or the like that do not require cutting, but only material movement, to form the threads. In implementations involving cutting, the flutes may be useful to deposit and eject/drop the cut material downward into the bore and out of the way of the threaded section.

The frangible taps disclosed herein are all seen to have a taper in the threaded portion, and a conical section below the threaded portion ending in a tip. Other frangible taps may have other configurations, such as having no taper, having no conical section and/or no tip, having a flat bottom, and/or so forth (for example a bottoming taper or plug taper are example options).

In implementations, any frangible section disclosed herein may be applied or may exist only in the shank, or only in the drive, or in both the shank and the drive.

The frangible sections disclosed herein may be applied to taps which do not initially form threads in a bore but which instead finish, refine, or touch-up threads already created by another tap. Such a finishing tap, nevertheless, is “configured to form threads,” as that phrase is used herein, inasmuch as it is configured to further form the threads relative to an unfinished thread configuration. Accordingly, such a finishing tap may constitute a frangible tap as encompassed by the claims below even if it is not intended to initially form threads, but only to finish threads already initiated by another tap.

The teeth of the threaded section of each frangible tap are seen to have grooves therebetween. The teeth may be called cutting teeth in implementations, as they may form threads in the respective cavity, bore, hole, or the like during the threading operation. However, in some cases the teeth may not technically be “cutting teeth” as they may form threads in a softer metal or other material by moving the material into a threaded configuration as opposed to actually cutting threads into it.

The various devices and/or assemblies disclosed herein and their elements, sub-elements, sub-assemblies, and so forth may be formed from any materials that will feasibly allow, facilitate, and/or otherwise not hinder their respective functions as described herein. For example, any of the devices, elements, or sub-elements may, wherever possible, be formed of metals, metal alloys, intermetallics, composites, ceramic materials, and so forth.

The above-described elements may in implementations be configured or arranged in a variety of configurations/arrangements, each configuration/arrangement with its own advantages as will be understood by the practitioner of ordinary skill in the art, notwithstanding the specific example configurations/arrangements which are discussed above and representatively illustrated in the drawings.

For convenience, a list of elements depicted in the drawings is provided below:
conventional tap 100
   shank 102
   flutes 104
   teeth 106
   conical portion 108
   tip 110
   tapered portion 112
   drive 114
      faces 116
   fracture 118
material 200
   cavity 202
wrench 204
frangible tap 300
   shank 302
   flutes 304
   threaded portion 305
   teeth 306
   conical portion 308
   tip 310
   tapered portion 312
   drive 314
      faces 316
   fracture 318
   frangible section 319
   first surfaces 320
   second surfaces 322
      angle 323
   cross-sectional area 324
   cross-sectional area 326
   top 328
frangible tap 400
   shank 402
   flutes 404
   teeth 406
   conical portion 408
   tip 410
   tapered portion 412
   drive 414
      faces 416
   frangible section 418
      first surface 419
      second surface 420
      helical line 421
frangible tap 500
   through-hole 502
   inner surface 504
frangible tap 550
   first surfaces 552
   second surfaces 554
frangible tap 600
   upper surface 602
   lower surface 604
frangible tap 650
   upper surfaces 652
   lower surfaces 654
frangible tap 700
   upper surfaces 702
   lower surfaces 704
frangible tap 750
   first surfaces 752
   second surfaces 754
frangible tap 800
   first surfaces 802
   second surfaces 804
frangible tap 900
   modified section 902
   thickness 904
   blind hole 906
   outer surface 908
frangible tap 950
   frangible section 952
   recess 954
   surface 956
   surface 958
   surface 960
frangible tap 970
   frangible section 971
   recesses 972
   surfaces 974
   surfaces 976
   surfaces 978

Wherever this disclosure refers to an axis, an axis of rotation, a rotational axis, or the like, of any tap or frangible tap, it is meant to convey the axis of rotation of the tap or frangible tap during a threading operation, unless otherwise stated in any specific instance.

It is pointed out there that, in some cases, a frangible tap would not need to have a smaller cross-sectional area than the smallest cross-sectional area of the threaded section (or of a portion of the threaded section that engages with a bore for forming threads) in order to function properly. Some examples are given herein, for example the above discussion of thermal treatments or microcracks/microfractures which may result in the frangible section being weaker even though it technically has a larger cross-section than the largest cross-sectional area of the threaded section (for example frangible sections that are thermally treated or provided with microcracks/microfractures but not having any cavities/voids therein, or having only relatively small cavities/voids such that the cross-sectional area of the frangible section exceeds the largest cross-sectional area of the threaded section). In other implementations (and even, for example, some of the implementations shown in the drawings) the frangible section may be weaker than the threaded section by virtue of the specific shape of the frangible section and so the frangible section may tend to break first under torsion even though the cross-sectional area at the break may be larger than the largest cross-sectional area of the threaded portion. Thus, whether the frangible section includes one or more recesses and/or one or more cavities, or not, the frangible section may still be designed to break prior to the threaded section even if its cross-sectional area exceeds the greatest cross-sectional area of the threaded section.

It can be seen from the drawings that, for each frangible tap, the shank is coupled with the drive and the threaded section is coupled with the shank. The frangible section of each frangible tap is configured to be weaker than the corresponding threaded section under torsion such that, while using the frangible tap for a threading operation, the frangible section is configured to fracture under a torsional stress lower than what would fracture the threaded section. In some cases this is accomplished by the frangible section having a cross-section smaller than a smallest cross-section of the threaded section, both cross-sections taken orthogonal to the axis of rotation of the frangible tap. In other cases this is accomplished by the frangible section having a cross-section smaller than a smallest cross-section of a portion of the threaded section that engages a sidewall of the bore during a threading operation. For example, referring to FIG. 15, it can be seen that not all of the threaded section engages the sidewall of the respective bore in some threading operations, but only a portion of the threaded section engages the bore sidewall. In such implementations the threaded section could theoretically have a cross-section, taken somewhere in the non-engaged portion, that is smaller than the cross-section of the frangible portion, and the frangible portion may still operate to fail before the threaded section because the non-engaged portion of the threaded section may not be under the same level of torsional stress, in such a scenario, as the frangible section. In implementations the smaller cross-sectional area of the frangible portion is accomplished by the presence of a recess or cavity in the frangible section. In some cases the frangible section is made weaker than the threaded section (under torsion) only in part by the relative cross-sectional areas, and also in part by other mechanisms disclosed herein.

In implementations formation of the frangible section, whether by removal of material, a thermal treatment, introducing microcracks or microfractures, or any other method disclosed herein, reduces a maximum supportable torsional stress of the frangible tap (at the frangible section), such that the frangible tap is configured to break at the frangible section instead of at the threaded section under a threshold level of torsional stress.

While each individual above-described element may be configured as shown in the drawings and/or as discussed above, these are only representative examples, and other configurations are possible for any individual element, with various advantages and tradeoffs as will be understood by the practitioner of ordinary skill in the art.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of frangible taps and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

In implementations “substantially cylindrical,” as used herein, mean 80% or more cylindrical. In implementations “substantially cylindrical” as used herein, means that the shank is cylindrical except for the frangible section and except for any flutes extending into the shank.

It is noted that the manual and power drivers are not shown in the drawings because they are well-known in the art such that they do not need to be shown for the practitioner of ordinary skill in the art to understand their use relative to the taps disclosed herein.

“Above” (and similar wording) as used in this document refers to a direction away from a bottom of a frangible tap, while “below” (and similar wording) refers to a direction away from a top of a frangible tap, unless otherwise indicated.

It is pointed out that microcracks and microfractures are not specifically shown in the drawings, due in part to their being (in implementations) not visible to the naked eye, but it is pointed out that the methods and mechanisms disclosed herein are sufficient to allow the practitioner of ordinary skill in the art to introduce microcracks and microfractures in the frangible sections notwithstanding their not specifically being shown in the drawings.

Method steps disclosed anywhere herein, including in the claims, may be performed in any feasible/possible order. Recitation of method steps in any given order in the claims or elsewhere does not imply that the steps must be performed in that order—such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A frangible tap, comprising:
a drive shaped and sized to be driven by a manual or power driver to rotate the frangible tap;
a shank coupled with the drive;
a threaded section coupled with the shank, the threaded section comprising a plurality of teeth configured to form threads in a bore by rotation of the threaded section within the bore; and
a frangible section formed in one of the shank and the drive, the frangible section configured to be weaker than the threaded section under torsion, such that the frangible section is configured to fracture under a torsional stress lower than what would fracture the threaded section.

2. The frangible tap of claim 1, wherein the frangible section comprises a recess or a cavity.

3. The frangible tap of claim 2, wherein a presence of the recess or the cavity causes the frangible section to have a cross-sectional area smaller than a smallest cross-sectional area of a portion of the threaded section engaging a sidewall of the bore, both cross-sectional areas taken orthogonal to a rotational axis of the frangible tap.

4. The frangible tap of claim 1, wherein all of the frangible section is located above the threaded section and below the drive.

5. The frangible tap of claim 4, further comprising a plurality of flutes extending at least partially into the threaded section, and wherein all of the frangible section is located above the plurality of flutes and below the drive.

6. The frangible tap of claim 1, wherein the frangible section is configured to fracture under the torsional stress due to having a modified section that is weakened, relative to the threaded section, using a thermal treatment.

7. The frangible tap of claim 1, wherein the frangible section is configured to fracture under the torsional stress due to having a modified section that is weakened, relative to the threaded section, using microfractures or microcracks.

8. A frangible tap, comprising:
a drive shaped and sized to be driven by a manual or power driver to rotate the frangible tap;
a shank coupled with the drive;
a threaded section coupled with the shank, the threaded section comprising a plurality of teeth configured to form threads in a bore by rotation of the threaded section within the bore; and
a frangible section in one of the shank and the drive, the frangible section comprising a recess or a cavity;
wherein a presence of the recess or the cavity causes the frangible section to have a cross-sectional area smaller than a smallest cross-sectional area of a portion of the threaded section engaged with a sidewall of the bore, both cross-sectional areas taken orthogonal to a rotational axis of the frangible tap; and
wherein, due at least in part to the cross-sectional area of the frangible section, the frangible section is configured to be weaker than the threaded section under torsion, such that the frangible section is configured to fracture under a torsional stress lower than what would fracture the threaded section.

9. The frangible tap of claim 8, wherein the frangible section comprises the cavity, and wherein the cavity is not visible at an outer surface of the shank.

10. The frangible tap of claim 8, wherein the frangible section comprises the recess, and wherein the recess is formed into a notch comprising at least two flat surfaces having an angle therebetween.

11. The frangible tap of claim 8, wherein the frangible section comprises the recess, and wherein the recess encircles the shank in a helical manner.

12. The frangible tap of claim 8, wherein all of the frangible section is located above the threaded section and below the drive.

13. The frangible tap of claim 12, further comprising a plurality of flutes extending at least partially into the threaded section, wherein all of the frangible section is located above the plurality of flutes and below the drive, and wherein the shank is substantially cylindrical except for the frangible section and except for the plurality of flutes.

14. The frangible tap of claim 8, wherein the frangible section comprises the cavity, and wherein the cavity is accessible through at least two openings in an outer surface of the shank.

15. The frangible tap of claim 8, wherein the frangible section comprises the cavity, and wherein the cavity comprises a blind hole that is accessible through an opening in the drive but that is not accessible through any outer surface of the shank.

16. The frangible tap of claim 8, wherein the frangible section comprises the recess as well as one or more other recesses together forming a plurality of recesses, wherein the plurality of recesses are symmetric to one another relative to the rotational axis of the frangible tap.

17. The frangible tap of claim 8, wherein the frangible section comprises the recess as well as one or more other recesses together forming a plurality of recesses, wherein the plurality of recesses are asymmetric to one another relative to the rotational axis of the frangible tap.

18. A method of forming a frangible tap, comprising:
forming a frangible section in a tap, the tap comprising:
a drive shaped and sized to be driven by a manual or power driver to rotate the tap;
a shank coupled with the drive; and
a threaded section coupled with the shank, the threaded section comprising a plurality of teeth configured to form threads in a bore by rotation of the threaded section within the bore;
wherein the frangible section is formed in one of the shank and the drive; and
wherein the frangible section is weaker than the threaded section under torsion, such that the frangible section is configured to fracture under a torsional stress lower than what would fracture the threaded section.

19. The method of claim 18, wherein forming the frangible section comprises forming a recess or a cavity in one of the shank and the drive, wherein a presence of the recess or the cavity causes the frangible section to have a cross-sectional area smaller than a smallest cross-sectional area of a portion of the threaded section configured to engage a bore during a threading operation, both cross-sectional areas taken orthogonal to a rotational axis of the frangible tap.

20. The method of claim 18, wherein forming the frangible section comprises weakening a portion of one of the shank and the drive to reduce a maximum supportable torsional stress by:
applying a thermal treatment; or
introducing microcracks or microfractures.
